(19) United States
(12) Patent Application Publication
(10) Pub. No.: US 2002/0125783 A1
(43) Pub. Date: Sep. 12, 2002

(54) Switched reluctance motor delivering constant torque from three phase sinusoidal voltages

(76) Inventor: Fernando B. Morinigo, Los Angeles, CA (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/799,973

(22) Filed: Mar. 5, 2001

Related U.S. Application Data
(60) Provisional application No. 60/262,830, filed on Jan. 19, 2001.

(51) Int. Cl. H02K 1/00; H02K 1/22

(52) U.S. Cl. 310/179; 310/261

(57) ABSTRACT

The physical characteristics of a switched reluctance motor that is able to produce constant torque when driven by three phase sinusoidal voltages are disclosed. The main requirement is that the coil inductances have a sinusoidal variation of inductance as a function of rotor angle. The required angular variation of the inductance is achievable by selecting certain proportions of stator and rotor pole widths, and stacking the rotor laminates in a particular spiral pattern. The constant torque is possible only for certain specific values of the number of salient rotor and stator poles in a combination not previously used in switched reluctance motors. When the three coils are connected in standard “Y” connection and the junction is not grounded, but left floating, the voltage at the junction becomes a sensor for the mechanical speed and position of the rotor, since it will have an electrical frequency that is a multiple of the rotor angular frequency plus the input electrical frequency, and a phase relative to the applied voltages that uniquely determines the angular position of the rotor.

### CROSS REFERENCE TO RELATED APPLICATIONS

Priority is claimed from Provisional Application No. 60/262,830, filed on Jan. 19, 2001.

### BACKGROUND OF THE INVENTION

1). Field of the Invention

This invention relates to a reluctance motor or generator.

2). Discussion of Related Art

Switched reluctance motors have been a fertile ground for the exercise of inventive ingenuity during the last generation. A search for the phrase “switched reluctance motor” in a patents data base [such as www.delphion.com] readily identifies hundreds of patents of recent date that collectively define the status of prior art, e.g. U.S. Pat. No. 5,936,373. The principal advantages of switched reluctance motors are their potential very high efficiency and their inexpensive and simple construction.

One disadvantage evident in prior art is the fact that prior art switched reluctance motors, under all previously known conditions of load or speed, produce oscillating torques. The so called ripple of the torque is strongly correlated with production of noise during the operation of the motor, at a level substantial enough to make the motor unacceptable for many applications.

Another disadvantage of prior art switched reluctance motors is the complexity of systems required to determine the precise position of rotor poles relative to stator poles thereof. Without a precise determination of position, it is impossible for the drivers of switched reluctance motors to guarantee operation, let alone operation at a good efficiency. Prior art rotor locating systems and procedures are of various types. There are those that rely on external sensors and position encoders, which require separate power supplies and add both cost and failure points to the system. There are those that attempt to extract the information by way of complex software that analyzes the voltage current relationships in the drive coils. This style of analysis in the past has often yielded ambiguous and insufficiently precise results for reliable and efficient operation.

### BRIEF DESCRIPTION OF THE DRAWINGS

The invention is further described by way of example with reference to the accompanying drawings wherein:

FIG. 1 is a graph of torque on a rotor against current on one coil only;

FIG. 2 is a graph of torque created on each of several rotor poles in steady state operation;

FIG. 3 is a cross sectional side view of a reluctance motor according to an embodiment of the invention; and

FIG. 4 is a projection of surface areas of stator poles and rotor poles of the reluctance motor.

### SUMMARY OF THE INVENTION

The invention provides a reluctance motor the kind having a stator defining a rotor housing, a rotor in the rotor housing and mounted to the housing for rotation about a drive axis, a plurality of rotor poles on the rotor and rotating together with the rotor about the axis, and a plurality of conductors, each being formed into a respective electromagnetic coil, the coils being secured to the housing about the rotor so that selective variation and current through the conductors causes rotation of the rotor poles and the rotor above the drive axis.

According to one aspect of the invention there are more rotor poles than coils.

According to another aspect of the invention, the inductance created is substantially sinusoidal and, together with sinusoidal change in currents in the conductors, a substantially constant torque is created.

According to a further aspect of the invention, ends of the conductors are connected to a common terminal in Y which provides a feedback signal to a control system which, in turn controls voltages applied to the conductors.

### DETAILED DESCRIPTION OF THE INVENTION

1. Coil Inductances Varying Sinusoidally with Rotor Angle:

The inductance L of any one coil of a switched reluctance motor must vary with angle, otherwise it is not possible for the motor to produce any torque whatsoever. The mathematical expression for how the torque is created as a function of the current and any one of the coil inductances is as follows:

τ=½I²(∂L/∂θ) [1]

where τ represents the torque in meter newtons, I represents the current in the coil in amperes, L represents the inductance in henrys, and the angle θ represents the position of the rotor with respect to the stator, in radian units.

In a switched reluctance motor constructed according to the present invention, the inductance of a single coil L varies with angle according to a sinusoidal function plus a constant, namely

L=L₀+λ cos(k[θ−φ]) [2]

where L₀ is a constant, equal to the mean inductance, λ is the amplitude of the inductance variations, θ is an angle measuring the rotor angular position from an arbitrary reference, φ represents the centroid of the location of one of the salient poles in the stator, and k is a wave number parameter whose magnitude equals the number of salient poles in the rotor. The magnitude of λ will necessarily be less than the value L₀ because inductances are inherently positive numbers in our convention. When θ=φ one pair of rotor salient poles is aligned, centered symmetrically opposite one pair of salient stator poles associated with one specific current phase.

For three phases, there are three such coils, conventionally located at angular locations separated by 2π/3 (120°), and the total torque is the sum of three terms,

τ=½Σ₁Iᵢ²(∂Lᵢ/∂θ) [3]

with the three inductances labeled by the index i, which takes on the values 1, 2, 3 having the same λ and k but differing in φ. The currents in the three inductances are denoted I₁, I₂, and I₃, and the three phases are denoted as φ₁ φ₂ φ₃. As shown in FIG. 1, if current flows in just one phase, torque on the rotor is a standing wave varying sinusoidally with position and having a magnitude proportional to the square of the current.

As an illustration of the type of special geometric characteristics of the design that follow from the sinusoidal character of the variation of inductance with angle, consider for a moment what would happen if the three currents I₁, I₂, and I₃ were to be of equal magnitude I. The torque would be proportional to a sum of three sines as follows:

τ=−½I²λk[sin(kθ−kφ₁)+ sin(kθ−kφ₂)+sin(kθ−kφ₃)] [4]

For the three phase switched reluctance machines that we are considering, the angles φᵢ are related so that

φ₂=φ₁+2π/3 φ_{3=φ}₁−2π/3 [5]

It can be readily shown by use of a standard trigonometric identity that under these circumstances the sum of the three sines is equal to

sin(kθ−kφ₁)[1+2 cos(2kπ/3)] [6]

which is identically zero provided only that the cosine of 2kπ/3 is equal to minus ½. This condition is satisfied provided the constant k has one of the following values:

k=3n±1 [7]

with n equal to zero or a positive or negative integer. This is equivalent to stating that k must be a nonzero integer, positive or negative, that does not contain 3 as a factor.

Earlier, k was described as a number having a magnitude equal to the number of salient poles of the rotor, that is, negative and positive numbers are equivalent for the purpose of counting rotor poles. It will turn out that the only values possible for constructing a constant torque switched reluctance motor similar in topology to the most common type of switched reluctance motor, but according to the principles of this invention, will be −4 and 8. In either case, the torque produced when currents of equal magnitude flow in the coils is identically zero, for any rotor position.

This result may be used to test the accuracy with which the inductances of a real motor match the mathematical prescription which is the basis of this invention.

2. Torques with sinusoidal currents:

The ability of the three phase switched reluctance motor to produce constant torque follows from the torque formula for the case that the currents in the three phases are all sinusoidal of the same frequency and amplitude, and displaced in time from each other by ±2π/3, as follows:

I₁=I₀ sin(ωt), I₂=I₀ sin(ωt−2π/3), I₃=I₀ sin(ωt+2π/3) [8]

where I₀ is an amplitude of current, ω is a constant denoting frequency and t is time.

The torque formula with these currents is given by the following expression:

τ=−½I₀²λk×[sin(ψ)sin²(ωt)+sin(ψ−k2π/3)sin²(ωt−2π/3)+sin(ψ+k2π/3)sin²(ωt+2π/3)] [9]

where ψ represents the combination kθ−kφ₁.

By the use of a standard trigonometric identity relating the square of a sine to the cosine of twice the angle, sin²A=½−½ cos(2A), we may convert each of the squares of the sines in the torque formula into the sum of a constant and a term involving twice the argument. The constant ½ terms are multiplied by a sum of sines that yield zero for the same reason that the torque for constant currents were zero, as in Eq. 6:

½[sin(ψ)+sin(ψ−k2π/3)+sin(ψ+k2π/3)]=0 [10]

The other pieces in the pattern, containing the factor −½ cos(2A) may be converted according to a trigonometric identity, sin A cos B=½ sin(A+B)+½ sin(A−B). With A representing the argument that contains ψ, and B representing the argument that contains ωt, we get six sine terms,

$$τ = ( 1 / 8 ) {I}_{o}^{2} λ k \times [ sin ( ψ + 2 ω t ) + sin ( ψ - 2 ω t ) + sin ( ψ - k 2 π / 3 + 2 ω t - 2 \times 2 π / 3 ) + sin ( ψ - k 2 π / 3 - 2 ω t + 2 \times 2 π / 3 ) + sin ( ψ + k 2 π / 3 + 2 ω t + 2 \times 2 π / 3 ) + sin ( ψ + k 2 π / 3 - 2 ω t - 2 \times 2 π / 3 ) ] \qquad [ 11 ]$$

these terms mathematically describe sinusoidal travelling waves, with three terms containing the plus combination (ψ+2ωt), and three terms containing the minus combination (ψ−2ωt).

If we ask whether any of these combinations can represent steady state solutions, we find that if we have a steady state solution based on setting one of the combinations of time and space variables equal to a constant, then the other combination adds up to zero, at least for certain values of the parameter k, for example, k=8 and k=−4, or, alternatively, k=−8 and k=4. Let us demonstrate this by separating the negatively travelling waves from the positively travelling waves, as follows with α=ψ+2ωt:

sin(ψ+2ωt)+sin(ψ−k2π/3+2ωt−2×2π/3)+sin(ψ+k2π/3+2ωt+2×2π/3)=sin(α)+sin(α−[k+2]×2π/3)+sin(α+[k+2]×2π/3)=sin(α){1+2 cos([k+2]×2π/3)} [12]

and as follows with β=ψ−2ωt:

sin(ψ−2ωt)+sin(ψ−k2π/3−2ωt+2×2π/3)+sin(ψ+k2π/3−2ωt−2×2π/3)=sin(β)+sin(β−[k−2]×2π/3)+sin(β+[k−2]×2π/3)=sin(β){1+2 cos([k−2]×2π/3)} [13]

The braces β combination equals three, because the cosine is the cosine of a multiple of 2π, for k=8 and k=−4, whereas these values make the braces quantity in the α combination vanish. On the other hand, the braces in the α combination contains the cosine of a multiple of 2π for k=−8 or k=4, and these values make the braces quantity in the β combination vanish. Steady torque travelling wave solutions exist. Either choice, namely making the α combination vanish, or making the β combination vanish, represents equivalent physical situations. Other values of k differing by 6 units from those listed lead to the same algebraic results, but, for the customary topology of switched reluctance motors, either rotors or stators cannot be physically built to correspond to those other integers and still have the inductances follow the sinusoidal formula.

In what follows, we choose to make the β combination the one that does not vanish, and it must be understood that it will be meaningful only with k=+8 or k=−4. The result is:

τ=(⅜)I₀²λk sin(kθ−kφ₁−2ωt) [14]

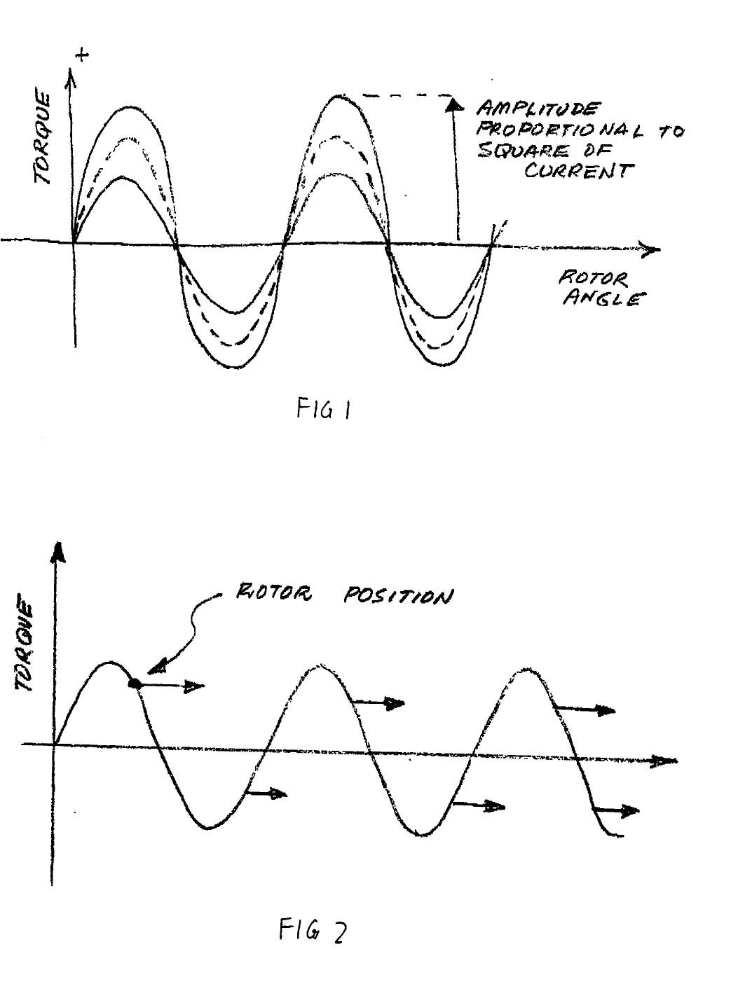

This equation implies that the torque will be constant, without ripple, if the argument of the sine function remains constant, which will happen if the mechanical angular velocity of the rotor is such that dθ/dt equals 2ω/k. This situation is shown in FIG. 2.

In the discussion above, φ₁ represented the location of the stator pole corresponding to the first phase, relative to an angular scale having an arbitrary reference zero. There is no loss of generality if it is agreed that the angular scale begins at the center of this stator pole, meaning that φ₁ can be set to zero for computational convenience. With this convention, we may write

τ=(⅜)I₀²λk sin(kθ−2ωt) [15]

The different steady state solutions correspond to different constant, ripple free values of the torque, which may be parametrized in terms of the argument of the sine, that is, setting the argument of the sine equal to a constant ε

kθ−2ωt=ε [16]

This equation will most often be used to define or select the electrical frequency ω required to produce constant torque.

Suppose that a rotor is moving in such a way that its equation of motion is

θ=θ₀+Ωt [17]

where Ω is the mechanical speed of rotation, and θ₀ is the position of the rotor at time zero. If we wish to impart a torque to the rotor, the torque being associated with a particular value of ε, the value of the electrical frequency ω must be set equal to Ωk/2. With this assignment, the preceding equation requires

kθ₀=ε [18]

which means, the position of the rotor at the instant that the current in coil 1 equals zero (with positive derivative) is what determines what the torque will be.

Among other things to note, the direction of the mechanical speed of rotation that corresponds to the steady state condition is correlated with the sign of k. If k=8, the steady state occurs with θ increasing with time, and Ω positive. With k=−4, the steady state occurs with θ decreasing with time, and Ω negative. The convention is that the electrical frequency ω is always considered positive. Torques may be positive or negative, and the operation of the device may be either as a motor (torque of the same sign as the speed of rotation of the rotor), or as a generator (torque of the opposite sign as the speed of rotation of the rotor).

The mechanical power associated with this steady state solution at constant torque is

τΩ=(¾)I₀²λω sin(ε) [19]

so that it is the sign of sin(ε) that determines whether the device is behaving as a motor or as a generator.

In general, within a cycle of 2π in the argument, there are two values of the parameter ε that correspond to the same value of the sine. These two differ in the values of the cosine, cos(ε), which is involved when we ask about the stability of the solution.

3. Voltages with Sinusoidal Current:

The voltage required by one coil, if the steady state solution of the preceding section is to be maintained, is obtained from the voltage equation for that coil,

Vᵢ=IᵢR+L₀∂ₜIᵢ+∂ₜ(λ cos(k[θ−φᵢ]Iᵢ) [20]

where R is the resistance of the coil, and we have used the abbreviation ∂ₜ to represent the derivative with respect to time of what follows. We insert the solution for θ that corresponds to the steady state solution, and the formula for the current in the phase Iᵢ, namely

θ=ε/k+(2ω/k)t, I₁=I₀ sin(ωt−φᵢ) [21]

The immediate result of the substitution is as follows:

Vᵢ=I₀R sin(ωt−φᵢ)+L₀I₀ω cos(ωt−φ₁)−I₀ sin(ω−φ₁)λ sin(ε+2ωt−kφᵢ)2ω [22]

The product of sines appearing on the right may be converted to a sum of cosines according to the identity sin A sin B=½ cos(A−B)−½ cos(A+B), with the following result:

Vᵢ=I₀{R sin(ωt−φᵢ)+L₀ω cos(ωt−φᵢ)−λω cos(ε+ωt−[k−1]φᵢ)+λω cos(ε+3ωt−[k+1]φᵢ)} [23]

To simplify this result further, we note that for the two values of k that we have said are of significance, namely k=8 and k=−4, [k+1]2π/3 is an integral multiple of 2π, which means we can set the combination [k+1]φᵢ equal to zero for all the phases, and the phase dependence of the last term, which involves the frequency 3ω, disappears, meaning that the term appears in equal form for any of the three phases. The combination [k−1]φ₁ can similarly be replaced by φ₁, because [8−1]=[6+1], and the 6 can be ignored, for all three phases, and [−4−1]=[−6+1], and the 6 can be ignored, too. The simplified expression is then

V₁=I₀{R sin(ωt−φᵢ)+L₀ω cos(ωt−φ₁)−λω cos(ε+ωt−φ₁)+λω cos(ε+3ωt)} [24]

4. Power Delivered or Generated in the Steady State:

Since the current at phase i is given by I₀ sin(ωt−φ₁), we can compute the instantaneous power in each phase and the mean power averaged over time. The only terms of Vᵢ that can contribute to the average power must have the frequency ω and must have the argument (ωt−φᵢ) in the sine. Then the mean of the square of the sine is replaced by ½ upon averaging. The resulting average power in any phase is as follows:

<VₜIᵢ>=½I₀²R+(¼)I₀²λω sin(ε) [25]

The first term is simply the ohmic power dissipated by the sinusoidal current in the phase coil, and the second term represents the power that goes into mechanical energy in the case of a motor, or that is extracted from the mechanical energy source in the case of a generator. For the three phase machine, the total mechanical energy is three times the mechanical energy in one phase, which corresponds to the preceding result obtained as the product of the torque τ times the mechanical speed of rotation Ω.

We may describe the voltage-current relationship at frequency ω in terms of an effective impedance consisting of an effective resistance and an effective inductance:

resistance=R+λω sin ε, inductance=L₀−λ cos ε [26]

The voltage at frequency 3ω is exactly the same for all three phases. If the three coils are connected in the so called Y connection, and the junction is not grounded, but left floating, then the currents that flow in the branches will depend only on the differences between the voltages, and a common voltage applied to all three branches, or missing from all three branches simultaneously, as if applied at the junction, will cancel out.

In the steady state condition that produces constant torque, therefore, sinusoidal three phase voltages applied to the three inductances will produce sinusoidal currents provided that the inductances are connected in Y connection and the junction is not grounded. The voltage at the Y junction has frequency 3ω and is displaced in phase by ε from the current, and the current is displaced from the voltage by an angle whose tangent is the ratio, effective inductance divided by effective resistance, as given by the last equation. The position of the rotor when the current in phase 1 is zero is θ₀=ε/k.

Once the power formula Eq. 25 has been established, it is possible to construct an estimate of the efficiency of the device when used in the ideal steady state, either as a motor or as a generator. There will be three phases, and the ohmic power dissipated and the total power in the three phases will be

ohmic power=(3/2)I₀²R, electric power=(3/2)I₀²R+(¾)I₀²λω sin(ε) [27]

In the case of a motor, sin(ε) will be positive. If we neglect all other losses, such as windage and hysteresis, the efficiency of a motor is estimated as follows:

motor efficiency=1/[1+2R/λω sin(ε)] [28]

In the case of a generator, sin(ε) will be negative, and the over all electric power will be negative, as will be the mechanical energy. The generator efficiency is estimated as the ratio of electric power output divided by mechanical power input:

generator efficiency=1+2R/λω sin(ε) [29]

which is less than 1 because the sine is negative.

5. Physical Realization of Sinusoidal Inductance Variations:

The desired sinusoidal variation of the coil inductances with rotor angle can be realized with sufficient accuracy over a useful, albeit limited, range of magnetomotive force. For sufficiently large magnetomotive force, the magnetic materials will approach saturation, and this effect will distort the sinusoidal angular dependence to a varying degree, depending on the nature of the materials and the degree of saturation.

It is assumed in what follows that the stator consists of a stack of laminates having a ring topology, with six identically shaped inward salient poles symmetrically disposed around the inner circumference, one pole every π/3 (60°). Poles that are π apart (180°) are wrapped with the same conductor and form part of one inductance.

It is also assumed in what follows that the rotor consists of a stack of laminates having a disc topology, with identically shaped outwardly salient poles disposed uniformly around the outer circumference.

The following geometric conditions will produce a viable design for the case of an eight pole rotor, k=8.

The individual laminations of the rotor have salient poles, eight in number, equally spaced over a full circumference, each with an angular width of π/12 (15°).

(2) The six stator salient poles, six in number, equally spaced over a full circumference, have an angular width of π/8 (22.5°).

(3) The rotor laminations are staggered in a spiral that twists through π/24 (7.5°) when stacked to form the complete rotor. The following geometric conditions will produce a viable design for the case of a four pole rotor, k=−4.

The individual laminations of the rotor have salient poles, four in number, equally spaced over a full circumference, each with an angular width of π/4 (45°).

(2) The stator salient poles, six in number, equally spaced over a full circumference, have an angular width of π/6 (30°). It is understood that stator poles diametrically opposite are part of the same inductance.

(3) The stator laminations are staggered in a spiral that twists through π/12 (15°) when stacked to form the complete stator.

Additional designs may be generated, in which the numbers of poles are an integral multiple of the above designs, and in which the pole angular widths are appropriately reduced, by division by the same integral multiple. For example, a stator might have 12 rather than 6 stator poles, and a corresponding rotor might have 16 rather than 8 salient poles. The number of phases would remain at three, with four of the stator poles actively magnetized when current flows in just one of the phases.

Designs with k=2, which are allowed by the mathematics, are not physically possible with the most common topology of prior art switched reluctance motors, in which the inductances of the three phases share the use of magnetic material volume. If the three inductances are offset axially, then designs of k=2 become possible, but the weight and volume of ferromagnetic material per unit inductance are increased by a substantial factor. The design that is most efficient in the use of magnetic material is for six salient stator poles and eight rotor poles. For relatively small motors, the design having six salient stator poles and four rotor poles may offer a small advantage because the fraction of the magnetic flux that leaks into useless volume is somewhat reduced, but the rotor capacity to act as a fan is much imparied.

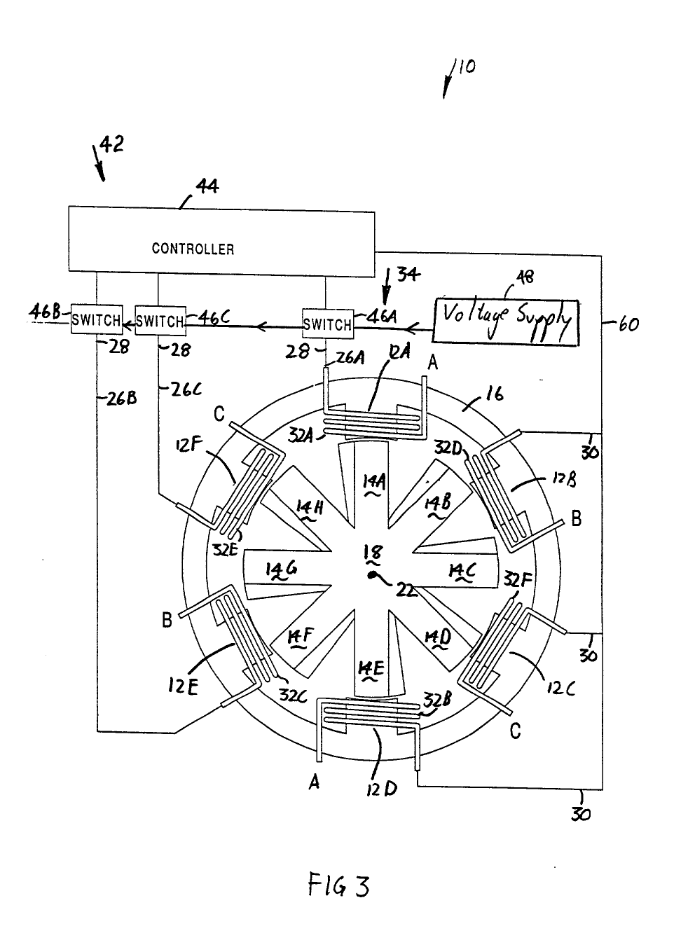

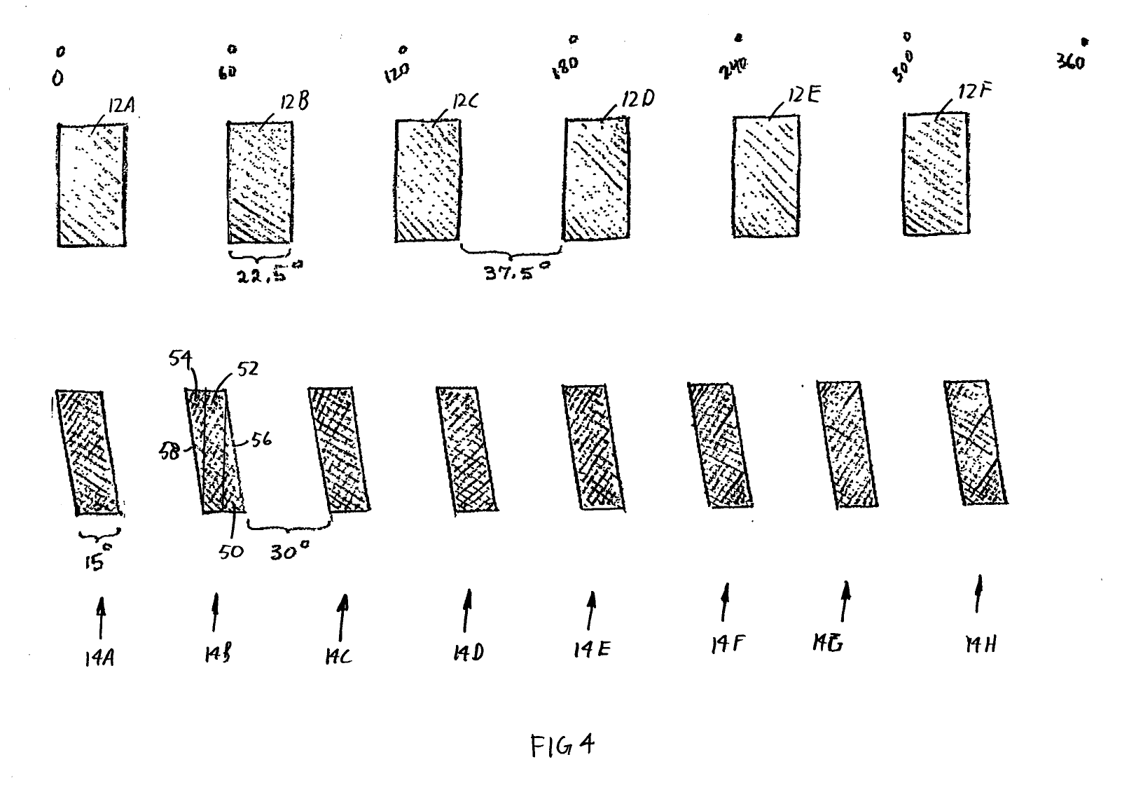

FIG. 3 of the accompanying drawings illustrates a reluctance motor 10 having six stator poles 12A-F and eight rotor poles 14A-H. The reluctance motor 10 also includes a stator 16 and a rotor 18. The stator 16, rotor 18, stator poles 12A-F and rotor poles 14A-H are all made of steel or another material that can be magnetized.

The stator 16 defines a cylindrical rotor housing 20. The rotor 18 is located within the rotor housing 20 and secured to the stator 16. The rotor 18 is rotatable about a drive axis 22 relative to the stator 16. The rotor poles 14 are located on and extend radially outwardly from the rotor 18. The rotor poles 14 are angularly spaced by 45° from one another.

The stator poles 12 are located on and extend radially inwardly from the stator 16. The stator poles 12 are angularly spaced by 60° from one another.

The reluctance motor 10 further includes three conductors 26A-C. each conductor 26 has a first end 28 and a second end 30. The conductor 26A has a first section closest to the first end 28 thereof which is wrapped into an electromagnetic coil 32A around the stator pole 12A. Another section of the conductor 26A between the coil 32A and the second end 30 thereof is wrapped into an electromagnetic coil 32B around the stator pole 12D. Both coils 32A and 32B are wrapped in the same direction, either both counterclockwise (as shown) or both clockwise (not illustrated), when viewed in a direction 34. When current flows in the conductor 26A, magnetic fields are created in the stator poles 12A and 12D. The magnetic fields in the stator poles 12A and 12D have flux lines that are generally parallel.

Similarly, the conductor 26B has a first section which is wrapped into an electromagnetic coil 32C about the stator pole 12E and a second section which is wrapped into an electromagnetic coil 32D about the stator pole 12B. The conductor 26C has a first section which is wrapped into an electromagnetic coil 32E about the stator pole 12F and an electromagnetic coil 32F wrapped about the stator pole 12C. Magnetic fields created in the stator poles 12B and 12E have flux lines that are generally parallel and magnetic fields created in the stator poles 12C and 12F have flux lines that are generally parallel.

The reluctance motor 10 further includes a control system 42 which includes a controller 44 and three variable switches 46A, 46B, and 46C. First ends 28 of the conductors 26A, B, and C are connected through a respective switch 46A, 46B, and 46C to a voltage supply 48. The controller 44 is a microprocessor-based controller which can be programmed to control the switches 46A-C so as to individually vary a voltage supplied by the voltage supply 48 to a respective one of the conductors 26A-C. In use, the controller 44 controls the switches 46A-C according to the formula in Eq. 24 so that currents in the switches 26A, 26B, and 26C are as given in Eq. 8. FIG. 4 illustrates alignment of the stator poles 12 with the rotor poles 14. Each stator pole has an inner surface projecting towards the rotor poles having a width of 22.5°. The stator poles are rectangular and are spaced from one another by 37.5°.

Each rotor pole 14 has a surface projecting towards the stator poles having first, second, and third areas 50, 52, and 54. A leading edge 56 of the first area 50 is spiraled about the rotor by 7.5°. A second area 52 follows the first area 50 and is rectangular with a width of 7.5°. The third area 54 follows the second area 52 and has a trailing edge 58 which spirals together with the leading edge 56 about the rotor by 7.5°.

When the rotor 18 rotates, a leading tip of the leading edge 56 is first exposed to one of the surfaces of the rotor poles. A quadratic increase in area with rotation angle then occurs as the more of the first area 50 is exposed. After 7.5°, a leading edge of the second area 52 is exposed. Further rotation through 7.5° causes a linear increase in exposure of the second surface 52. After a total of 15°, the third surface 54 is progressively exposed. The third surface 54 is exposed increasing quadratically towards a maximum until a trailing tip of the trailing edge 54 is exposed. At that moment in time the entire first, second, and third surfaces 50, 52, and 54 are exposed. It can be seen that the surface of the rotor pole 14 is progressively exposed over 22.5° in a manner which is substantially sinusoidal. Further rotation of the rotor pole piece 14 causes a decrease in exposure which is also substantially sinusoidal. The decrease is also for 22.5°. A sinusoidal increase and decrease thus occurs over 45°. There are eight rotor pole pieces which sequentially are exposed to one stator pole 12 in a sinusoidal manner over 45°. Exposure to a particular pole 12 is thus substantially continuously sinusoidal over 360°. Such sinusoidal exposure leads to a change in inductance by a particular pole piece which substantially follows Eq. 2.

The second ends 30 of the conductors 26A-C are connected to a common terminal 60 in Y. The terminal 60 is connected to the controller so that a feedback signal is provided by the terminal 60 to the controller 44. The controller 44 utilizes the signal from the terminal 60 to control switching of the switches 46A-C.

6. Equations Valid when Coils are Connected in Y:

All of the equations displayed above involve describing the steady state conditions for the system. Since achieving the steady state is not automatic, algorithms must be developed so that the control system can start from an arbitrary state and apply appropriate voltages so that the steady state condition is approached. In this section certain mathematical transformations are applied to display certain other properties of the system that are believed to be crucial for the development of algorithms to approach the steady state under active control.

One first step is to introduce the notation λ₁ λ₂ λ₃ to denote the varying part of the inductances,

λ₁=λ sin(k[θ−φ_{2]) λ}₂=λ sin(k[θ−φ₂]) λ₃=λ sin(k[θ−φ₃]) [30]

A useful next step is to write general electrical equations to describe a system of three equivalent inductances hooked together in Y connection. For the time being, assume that the Y connection is connected to ground through a resistance R_{g}. Eventually the limit as R_{g}→∞ will be considered. The three individual equations

$$\begin{matrix}{V}_{1} = {I}_{1} R + {L}_{o} {\partial }_{t} {I}_{1} + {\partial }_{t} {( {λ}_{1} {I}_{1} )}_{} + {R}_{g} ( {I}_{1} + {I}_{2} + {I}_{3} ) \\ {V}_{2} = {I}_{2} R + {L}_{o} {\partial }_{t} {I}_{2} + {\partial }_{t} {( {λ}_{2} {I}_{2} )}_{} + {R}_{g} ( {I}_{1} + {I}_{2} + {I}_{3} ) \\ {V}_{3} = {I}_{3} R + {L}_{o} {\partial }_{t} {I}_{3} + {\partial }_{t} {( {λ}_{3} {I}_{3} )}_{} + {R}_{g} ( {I}_{1} + {I}_{2} + {I}_{3} )\end{matrix} \qquad [ 31 ]$$

may be considered together as a matrix equation for the current vector [I₁ I₂ I₃] given the voltage vector [V₁ V₂ V₃], and certain matrix factors that mix the original current elements. Let S represent a unitary transformation matrix, and let ξ η ζ represent currents transformed to a new basis, and let U_{ξ} U_{η} U_{ζ} represent similarly transformed voltages, as follows:

$$\begin{matrix}ξ & & {2}^{- 1 / 2} & - {2}^{- 1 / 2} & 0 & {I}_{1} \\ η & = & {6}^{- 1 / 2} & + {6}^{- 1 / 2} & - 2 \times {6}^{- 1 / 2} & {I}_{2} \\ ζ & & {3}^{- 1 / 2} & {3}^{- 1 / 2} & {3}^{- 1 / 2} & {I}_{3}\end{matrix} and \begin{matrix}{U}_{ξ} & & {2}^{- 1 / 2} & - {2}^{- 1 / 2} & 0 & {V}_{1} \\ {U}_{η} & = & {6}^{- 1 / 2} & + {6}^{- 1 / 2} & - 2 \times {6}^{- 1 / 2} & {V}_{2} \\ {U}_{ζ} & & {3}^{- 1 / 2} & {3}^{- 1 / 2} & {3}^{- 1 / 2} & {V}_{3}\end{matrix} \qquad [ 32 ]$$

The inverse transformation that recovers I₁ I₂ I₃ from ξ η ζ is S^{T} the transpose of S:

$$\begin{matrix}{I}_{1} & & {2}^{- 1 / 2} & {6}^{- 1 / 2} & {3}^{- 1 / 2} & ξ \\ {I}_{2} & = & - {2}^{- 1 / 2} & {6}^{- 1 / 2} & {3}^{- 1 / 2} & η \\ {I}_{3} & & 0 & - 2 \times {6}^{1 / 2} & {3}^{- 1 / 2} & ζ\end{matrix} and S {S}^{T} = {S}^{T} S = \begin{matrix}1 & 0 & 0 \\ 0 & 1 & 0 \\ 0 & 0 & 1\end{matrix} \qquad [ 33 ]$$

The variable parts of the inductances, represented by λ₁ λ₂ λ₃ must be transformed as though they were the elements of a diagonal matrix, and the terms proportional to R_{g} transform as the elements of a matrix whose elements are all equal. In any case, the result of applying the S transformation from the left to the set of three voltage equations, in such a way that the result is expressed entirely in the new representation, is as follows:

$$\begin{matrix}{U}_{ξ} = ξ R + {L}_{o} {\partial }_{t} ξ + 1 / 2 {\partial }_{t} ( {λ}_{x} ξ + {λ}_{y} η + {2}^{1 / 2} {λ}_{y} ζ ) \\ {U}_{η} = η R + {L}_{o} {\partial }_{t} η + 1 / 2 {\partial }_{t} ( {λ}_{y} ξ + {λ}_{x} η + {2}^{1 / 2} {λ}_{x} ζ ) \\ {U}_{ζ} = ζ ( R + 3 {R}_{g} ) + {L}_{o} {\partial }_{t} ζ + {2}^{- 1 / 2} {\partial }_{t} ( {λ}_{y} ξ + {λ}_{x} η )\end{matrix} \qquad [ 34 ]$$

We have introduced certain inductance parameters λₓ and λ_{y} that are linear combinations of the variable inductances λ₁ λ₂ and λ₃ of the original description, as follows:

λₓ=λ₁+λ₂ λ_{y}=(λ₁−λ₂)/3^{½} [35]

The third variable inductance is superfluous because of the identity 0=λ₁+λ₂+λ₃.

After some trigonometric identities, it may be established that

λₓ=−λ cos(k[θ−π/3]) λ_{y}=−λ sin(k[θ−π/3]) [36]

The standard three phase I₁ I₂ I₃ currents from Eq. 8 result in the following values for ξ and η

ξ=(3/2)^{½}I₀ cos(ωt+π/3) η=(3/2)^{½}I₀ sin(ωt+π/3) [37]

7. Perturbation Solutions:

The electrical equations will now be solved by the perturbation method. First, define the solutions for the special case λ=0 as the unperturbed solutions. Next, imagine that λ is not zero, but very small, and insert corrections to the unperturbed voltages and currents that are proportional to successive powers of λ. Third, collect the terms that have the same power of λ as a factor, and solve the equation that result from setting the coefficients of the various powers of λ equal to zero. Set

ξ=ξ₀+λξ₁+λ²ξ₂+ . . . η=η₀+λη₁+λ²η₂+ . . . ζ=ζ₀+λζ₁+λ²ζ₂+ . . . [38]

The questions to be addressed in this section are principally two: (1) what is the voltage signal at the common Y connection when a standard three phase voltage is applied, but the system is not in the steady state? and (2) can the voltage signal be interpreted so that the path to the desired steady state can be determined?

First, derive an expression for the equivalent voltages U_{ξ} U_{η} U_{ζ} corresponding to standard sinusoidal branch voltages that may be displaced in phase by φ from the current:

$$\begin{matrix}\begin{matrix}{V}_{1} = {V}_{o} sin ( ω t - ϕ ) , {V}_{2} = {V}_{o} sin ( ω t - ϕ - 2 π / 3 ) , {V}_{3} = {V}_{o} sin ( ω t - ϕ + 2 π / 3 ) \\ {U}_{ξ} = {2}^{- 1 / 2} {V}_{1} - {2}^{- 1 / 2} {V}_{2} = {2}^{- 1 / 2} {V}_{o} [ sin ( ω t - ϕ ) - sin ( ω t - ϕ - 2 π / 3 ) ] = {( 3 / 2 )}^{1 / 2} {V}_{o} cos ( ω t - ϕ - π / 3 ) \\ {U}_{η} = {6}^{- 1 / 2} {V}_{1} + {6}^{- 1 / 2} {V}_{2} - 2 \times {6}^{- 1 / 2} {V}_{3} = {( 3 / 2 )}^{1 / 2} {V}_{o} {sin ( ω t - ϕ - π / 3 )}_{} \\ {U}_{ζ} = 0\end{matrix} & \end{matrix} \qquad [ 39 ]$$

The second step is to generate the zero order perturbation solutions, that is, the solutions that would be valid in the limit that λ→0. By appropriately adjusting the voltage phase φ, the results can be put in this standard form:

ξ₀=(3/2)^{½}I₀ cos(ωt+π/3) η₀=(3/2)^{½}I₀ sin(ωt+π/3) ζ₀=0 [40]

The third step is to solve the equations that result from keeping the terms proportional to first order in λ. For the case of the ζ equation, we have, after setting ζ₀=0,

U_{ζ}=ζ(R+3R_{g})+L₀∂ₜζ+2^{-½}∂ₜ(λ_{y}ξ+λₓη)→0=λζ₁(R+3R_{g})+2^{-½}∂ₜ(λ_{y}ξ₀+λₓη₀) [41]

which can be readily solved for ζ₁. The voltage read at the junction must be equal to

(I₁+I₂+I₃)R_{g}=3^{½}λζ₁R_{g}=−2^{-½}/(R/R_{g}+3) [42]

In the limit that R_{g}→∞ the result is

V_{junction}=λI₀ω cos(k[θ−π/3]+[ωt+π/3]) [43]

For the k values of interest, namely 8 and −4, (k+1)π/3 may be replaced by π, which is equivalent to putting a minus sign in front of the expression.

V_{junction}=−λI₀ω cos(kθ+ωt) [44]

What this means is that, in the first order perturbation approximation, the phase of the voltage at the junction gives a precise indication of the rotor position, just as it did in the steady state case, but unrestricted as to rotor speed. A constant rotor speed, that is, when θ=θ₀+Ωt, the observed frequency of the junction voltage signal will be ω+kΩ.

Next, consider the ξ and η equations to first order in λ, assuming the limit R_{g}→∞ so that we may set ζ=0.

0=λξ₁R+L₀∂ₜλξ₁+½∂ₜ(λₓξ₀+λ_{y}η₀) [45a]

0=λη₁R+L₀∂ₜλη₁+½∂ₜ(λₓη₀+λ_{y}ξ₀) [45b]

The quantities whose time derivative is involved have the mathematical form of travelling waves, as follows:

λₓξ₀+λ_{y}η₀=−λ(3/2)^{½} cos(k[θ−π/3]−[ωt+π/3]) [46a]

λₓη₀+λ_{y}ξ₀=−λ(3/2)^{½} sin(k[θ−π/3]−[ωt+π/3]) [46b]

The resulting equations may be readily solved for ξ₁ and η₁. The total currents, ξ and η to this level of approximation consist of components having the frequency of the external voltage (the zero order terms) and additional components, proportional to λ having a frequency that is modified by the physical motion of the rotor, according to the travelling wave formulas. If the rotor motion is uniform, the frequency of the additional currents is kΩ−ωt.

Evidently, the perturbation solution method may be extended to higher orders. However, the number of frequencies involved stays limited to sums and differences of two fundamental frequencies, the applied voltage electrical frequency, and the equivalent frequency induced by the rotor motion.

8. Example of a Transient Solution:

The discussion has focused on steady state solutions. In practice, the interpretation of the voltage sensed at the junction will need to take into account transient solutions. In this section we compute, to first order in the perturbation expansion, what voltage may be expected if at time zero the rotor is rotating at constant mechanical speed Ω, there are no currents flowing in the inductances, and a voltage equivalent to a constant : U_{ξ}=U₀=U_{η} is applied beginning at t=0.

The transient solutions in zero order of λ is extremely simple to deduce, and it is the following:

ξ₀=(U₀/R)[1−e^{-Rt/Lo}]=η₀ [47]

Based upon these zero order solutions, by the method of the preceding section, and ignoring certain obvious constant factors, to concentrate on the time and angular dependence, the voltage at the junction is proportional to λ and to U₀/R and to

∂ₜ{sin(k[θ−π/3]+π/4)[1−e^{-Rt/Lo}]}=kΩ cos(k[θ−π/3]+π/4)[1−e^{-Rt/Lo}]+(R/L₀)e^{-Rt/Lo} sin(k[θ−π/3]+π/4) [48]

which means the alternating voltage signal will have a frequency of kΩ, modulated in amplitude by certain exponential factors.

In real motors designed according to the principles of this invention, the resistance R of the coils having a mean inductance L₀ will be made small enough that the ratio R/L₀ is very small compared to the frequencies kΩ induced by the mechanical motion, so that many cycles will occur within the characteristic decay time L₀/R.

9. Comparison of Standard 8/6 Designs with the Proposed 6/8 Design:

In this section, the characteristics of conventional, prior art designs involving eight stator poles and six rotor poles are compared to the characteristics of the proposed designs involving six stator poles and eight rotor poles. The designs are similar in that a torque impulse is created every

15° rotation of the rotor.

Number of phase coils (prior) 4

Number of phase coils (new) 3

maximum azimuthal space allocation per inductance, in degrees (prior) 90° maximum azimuthal space allocation per inductance, in degrees (new) 120°.

Since 4/3 as much space is available, the resistance of the coil inductances can be relatively reduced by approximately the inverse of this factor, and the ohmic losses can be reduced by approximately the square of the inverse, (3/4)² or 0.5625. This space and ohmic loss savings estimate is valid for stators having the same outside diameter and allowing for rotors having the same outside diameter.

The rotor in the conventional prior art design (8/6) rotates in a direction that is the opposite of the rotation of the magnetization sequence. In the new (6/8) design, the rotor rotates in a direction that is the same as the rotation of the magnetization sequence. This has a consequence for hysteresis losses, because the frequency of magnetization reversals for rotor material is substantially higher in the conventional prior art design than in the new design.

Possibly the most significant economic advantage of the (6/8) design as compared to the (8/6) design is in the number of coils, and in the number of electronic components required to generate the required power, the advantage being in the ratio 3/4.

10. On the Stability of the Steady State Solutions:

It is possible to get an indication of the stability of the steady state solution as follows. First, imagine that the system is in an ideal steady state corresponding to currents of amplitude I₀ and of torque magnitude corresponding to ε, according to Equations [15] through [19]. The rotor is assumed to have a moment of inertia J, and to be subject to a viscous drag force proportional in magnitude to the steady rotational speed Ω with proportionality constant γ.

If we let τ₀ represent the value of the torque in the steady state, we have

τ₀=(⅜)I₀² λk sin(ε)=γΩ [49]

The equation of motion for the rotor involves the moment of inertia and the general expression for the torque [15] provided by the motor.

Jd²θ/dt²=(⅜)I₀²γk sin(kθ−2ωt)−λdθ/dt [50]

We introduce an expression for θ consisting of the steady state solution plus a new arbitrary variable δ, defined by the relationship

θ=ε/k+Ωt+δ [51]

We insert [51] into [50] and then make the further stipulation that δ is very small so that we may set sin(kδ)=kδ and cos(kδ)=1 to a good approximation, to obtain the following differential equation for δ

Jd²δ/dt²=τ₀ cos εkδ−γdδ/dt [52]

This is recognizable as an equation for a variable that evolves with damped harmonic motion for cot ε negative, corresponding to a stable solution. An effect that produces a temporary small deviation from the ideal steady state will produce a small δ that evolves back down to zero. For cot ε positive, any temporary small deviation results in an increasing δ, corresponding to an unstable solution.

The preceding results indicate the following requirements for steady motor operation:

sin δpositive, cos δnegative [symbol] ½π<ε<π

and similarly, the following would be required for steady generator operation:

sin εnegative, cos εpositive [symbol] −½π<ε<0

11. Summary of Characteristics Different from Prior Art:

As herein described a three phase reluctance motor could be used straightforwardly as a direct replacement for three phase reluctance motors of prior art. In its preferred embodiment, it has torque characteristics very similar to a four phase reluctance motor of prior art having eight salient stator poles and six salient rotor poles. The differences and improvements with respect to prior art may be described in three paragraphs, as follows:

(1) The angular proportions of the salient poles and the spiral arrangement of the rotor laminates are adjusted so that the inductances of the three coils vary with rotor angle in a sinusoidal manner. This physical result has the characteristic that when sinusoidal currents of appropriate phase flow in the coils, the torque imparted to the rotor is constant, without ripple.

(2) The three phase coils are connected in “Y” pattern (also known as “star” pattern), and the center of the Y is not grounded, but left floating and its voltage used as a sensor voltage. When sinusoidal voltages of standard three phase format and of appropriate frequency are applied to the terminals, sinusoidal currents (and constant torque) result for the steady state. The voltage sensed at the floating center of the Y has a frequency, voltage and phase that is a precise and easily used indicator of the rotor mechanical frequency and phase as well as of the voltage amplitude applied. Thus, the wiring connection results in a robust sensor that is as durable as the motor primary coils.

(3) The preferred embodiment involves six stator salient poles and eight rotor salient poles, a combination that has not appeared before in disclosed art, and rotor laminates that are displaced from each other in a spiral. The six-eight combination allows more space for the copper wire of the coils, thus making the device have lower resistance and correspondingly higher efficiency. Also it allows for economy of construction, since the most nearly equivalent prior art motor would have four inductances and four separate electronic circuits, rather than three. The spiral arrangement of the rotor laminates acts as a fan, improving the cooling of the motor, and providing economies of space and device complexity in that a separate fan is not required.

What is claimed:

1. A reluctance motor comprising:
a stator defining a rotor housing;
a rotor in the housing and mounted to the housing for rotation about a drive axis;
a plurality of rotor poles on the rotor and rotating together with the rotor about the axis; and
a plurality of conductors, each being formed into a respective electromagnetic coil, the coils being secured to the housing about the rotor so that selective variation in current through the conductors causes rotation of the rotor poles and the rotor about the drive axis, there being more rotor poles than coils.

2. The reluctance motor of claim 1 comprising at least three coils, each carrying a respective one of three phases of current different from the other, and the number of rotor poles is given by k, where k is:
k=3n±1 with n equal to zero or a positive or negative integer.

3. The reluctance motor of claim 2 wherein k is 8.

4. The reluctance motor of claim 3 comprising at least six coils in three respective pairs, each pair carrying a respective phase of current.

5. The reluctance motor of claim 1 wherein a torque on the rotor is given by τ, where
τ=½Σ₁Iₜ²(∂Lₜ/∂θ)
where τ represents the torque in meter newtons, Iₜ represents the current in a respective coil in amperes, Lᵢ represents the inductance in henrys, and the angle θ represents the position of the rotor with respect to the stator, in radian units,
the rotor being constructed so that L₁ is sinusoidal.

6. The reluctance motor of claim 5 wherein L is substantially given by the following equation
L=L₀+λ cos(k[θ−φ])
where L₀ is a constant, equal to the mean inductance, λ is the amplitude of the inductance variations, θ is an angle measuring the rotor angular position from an arbitrary reference, and φ represents the centroid of the location of one of the salient poles in the stator.

7. The reluctance motor of claim 5 wherein the rotor pole has an outer surface having an edge that spirals about the rotor.

8. The reluctance motor of claim 7 wherein the surface has leading and trailing edges that spiral about the rotor.

9. The reluctance motor of claim 8 wherein a trailing tip of the leading edge is angularly spaced from a leading tip of the trailing edge.

10. The reluctance motor of claim 9 wherein the coils are at angles φ₁ φ₂ φ₃ about the rotor, wherein
φ₂=φ₁+2π/3 φ₃=φ₁−2π/3

11. The reluctance motor of claim 10 further comprising:
a control system which controls current provided to the conductors.

12. The reluctance motor of claim 11 wherein the currents are sinusoidal.

13. The reluctance motor of claim 12 wherein the three phases are represented by
I₁=I₀ sin(ωt), I₂=I₀ sin(ωt−2π/3), I₃=I₀ sin(ωt+2π/3)
where I₀ is an amplitude of current, ω is a constant denoting frequency and t is time.

14. The reluctance motor of claim 11 wherein first ends of the conductors are connected to a voltage supply and second, opposing ends of the conductors are connected to a common junction, the controller being connected to the junction so that a feedback signal is provided by the junction to the controller, the controller controlling voltages supplied to the conductors dependent on the feedback signal.

15. A reluctance motor comprising:
a stator defining a rotor housing;
a rotor in the housing and mounted to the housing for rotation about a drive axis;
a plurality of rotor poles on the rotor and rotating together with the rotor about the axis;
at least three conductors, each being formed into a respective electromagnet coil, the coils being secured to the housing about the rotor; and
a control system which controls current provided to the conductors in a manner which selectively varies currents through the conductors so that a torque is created on the rotor according to the following
τ=½Σ₁²(∂Lᵢ/∂θ)
where τ represents the torque in meter newtons, Iᵢ represents the current in a respective coil in amperes, Lₗ represents the inductance in henrys, and the angle θ represents the position of the rotor with respect to the stator, in radian units, the rotor being constructed so that L_{I} is sinusoidal and I_{I} is controlled by the control system to be sinusoidal.

16. The reluctance motor of claim 15 wherein Lᵢ is substantially given by the following equation
Lₜ=L₀+λ cos(k[θ−φ])
where L₀ is a constant, equal to the mean inductance, λ is the amplitude of the inductance variations, and φ represents the centroid of the location of one of the salient poles in the stator.

17. The reluctance motor of claim 15 wherein the control system controls a respective current (Iₜ) as follows:
I₁=I₀ sin(ωt), I₂=I₀ sin(ωt−2π/3), I₃=I₀ sin(ωt+2π/3)
where I₀ is an amplitude of current, ω is a constant denoting frequency and t is time.

18. A reluctance motor comprising:
a stator defining a rotor housing;
a rotor in the housing and mounted to the housing for rotation about a drive axis;
a plurality of rotor poles on the rotor and rotating together with the rotor about the axis;
at least three conductors, each having first and second opposed ends and having a respective section being formed into a respective electromagnet coil, the coils being secured to the housing about the rotor, the first ends being connectable to a voltage supply and the second ends being connected to a common junction; and
a control system which is connected to the junction so as to receive a feedback signal from the junction and utilizes the feedback signal to control current supplied by the voltage supply to the first ends of the conductors.

19. The reluctance motor of claim 18 wherein the feedback signal is proportional to ω+kΩ where ω is a constant denoting frequency of a respective phase of current through a respective conductor, k is the number of rotor poles Ω is the rotational speed of the rotor.
